(19) United States
(12) Patent Application Publication
(10) Pub. No.: US 2011/0087569 A1
(43) Pub. Date: Apr. 14, 2011

(54) Profit and loss sharing banking system / PLS banking system

(76) Inventors: Bijan Bidabad, Tehran (IR); Firouz Bidabad, Tehran (IR)

(21) Appl. No.: 12/588,188

(22) Filed: Oct. 7, 2009

(51) Int. Cl. G06Q 40/00

(52) U.S. Cl. 705/30; 705/37

(57) ABSTRACT

We introduce PLS Banking. This new banking system can easily be embedded and executed by conventional existing banks or other financial institutions within proposed framework and defined products. To overcome the problems of weak relationship between rate of return in real economy and interest rate in monetary sector Riba (usury) is to be vanished and be replaced by PLS mechanism.

In PLS Bank/Financial institution, determination of interest rate of loans is based on real economy sector return. The PLS Bank operates as an intermediary who collects saving resources and as an attorney or legal representative of depositor, leading them to invest in projects and supervises the detailed operation of the entrepreneur/s of the project. The yields of investment will be transferred to depositors whatever profit or losses. A trustee agent (Amin) is a unit who supervises the entrepreneur operations on behalf of the PLS Bank for honest carrying out of the project, controlling on executive operations along announced programs, resources allocation manner, and auditing financial statements and so on.

PLS banking will use new financial instruments and innovations such as:
Mosharekeh (partnership) certificates for finitude projects with specific ends.
Pazireh (subscripted) certificates for endless (productive) projects.
Establishing of secondary exchange market for transaction of certificates.
An electronic market for transactions of certificates through internet portal.
Various insurance services for increasing the efficiency of newly established virtual markets.

All of activities in PLS Banking will be done based on compiled instructions.

### BACKGROUND OF THE INVENTION

Today, the global economy shows the lowest interest rate and the Global economy recession is going to propagate to whole the world. The bankruptcy and deficits of some European banks and higher financial risks at international financial markets and sequential crises in these markets illustrate the symptoms of this crisis—same as 1929 world crisis. Investment and saving inconsistency in western economies especially in the Unites States pushed the globe economy to the phenomena of liquidity trap in 1929 crisis. There are only negative interest rates that are able to motivate economy and pull it up from the bottom of the cycle! In this case monetary policy does not work, because interest rate cannot be pushed to lower rates by increasing money supply. When the economy falls into the liquidity trap, there is no monetary policies solution via either increasing volume of liquidity or decreasing the interest rate to motivate investment demand to recover the economy.

Principally, liquidity trap is caused due to weak relationship between the rate of return in real economy sector and interest rate in monetary sector; when the interest rate moves to lower rates but investment rate of return does not. A reason of occurrence of such a case is the increase of investment risks, which decreases the net return of capital. The risk becomes a wide premium of financial market's interest rate and investment market's return rate. On the other hand, the difference of interest rate and investment rate of return increases.

A solution to solve this deficiency that is weak relationship between the rate of return in real economy sector and interest rate in monetary sector has been expressed by religious legislators through deletion of usury from the economy. The religious legislations (in Torah and Quran) actually have removed the intermediate monetary market between depositors and investors by prohibition of usury and establishing a proportional relationship between profit and loss of investors and the receipts of depositors. Thus, it is not an exaggeration to say that the solution to prevent global crisis similar to the previous century crisis is to delete usury from the monetary sector and establishing profit and loss sharing between depositors and investors (entrepreneurs). Real sector return rate is a stable rate, because of stability of productivity, and will not fall down drastically. Establishment of profit and loss sharing will stabilize the interest rate due to strengthening the link of interest rate in money market and rate of return of investment in real sector. Thus, inconsistency between investment and saving, and the liquidity trap will not happen in the economy to push the economy to crisis. However, business cycle will not vanish from the economy but the cycles' swings will have narrow volatility domain.

Despite of many developments and endeavors during past decades to apply non-usuric banking, this dream has never been settled down to make Islamic banking operational up to date. What we are calling now PLS banking is the practical and applicable solution to this problem as a well-defined operational mechanism. It is a complete set of new methodology, procedures of implementation, operation instructions, software operational design and mechanism of supervision and control accordingly.

Up to now, the obstacles to apply suitable executive mechanism and definition of operations/procedures and their feasibility in application of Non Usuric Banking failed. Non Usuric Banking and its procedures all the times has been mixed with usuric banking and even its financial instruments (innovations) as “profit and lost sharing certificate” and “investment deposit certificate” which attracted attention in late 1990's were left aside. This contamination occurred on executive and supervision problems on the operation of entrepreneurs who receive the financial resources, in all financial, economic, technical and executive aspects, and up to now an appropriate solution has not been found to define the procedures enabling banks to supervise the detailed operations of the investments, neither required banking products meeting the needs.

Therefore, the banks manipulated non-usury rates into interest rate and actually, they entered the interest rate into the calculation—though the existence of usury was not very obvious in the calculations. However, by scrutinizing the loan calculations the amount of interest were computable. Another problem is that the juristic inferences about usury in different Islamic sects are different and this subject caused some differentials in usury definitions. Different definitions produced different non-usuric banking products at international level, in a case that some of these products were not consistent with similar products of other banks. Even in Iran, where the consistency was more than other countries the same result happened and also the jurist's and economists' consensus in the time of approving “the law of non-usury banking” in early 1980's went to conflicts.

Thus, the general solution for establishment of original Islamic banking needed to revise the whole problem from the basis. The present proposition is the result of tough researches during the last ten years. We did our best to infer the opinion of religion's legislator according to the logic and rationality of theosophy (wisdom). We re-inferred the concept of usury. Thus, some measures for distinguishing usury from non-usury were defined. These measures explicitly define the non-usuric operations as the following items:

1—The sharing of loaner in Profit and Loss of loanee (borrower)

2—Non conditioning and not predetermination of interest in advance

3—Foreign exchanges (without time-based interest) are non-usuric

4—All interests received from consumption loans are usuric

By these measures in the next round, we examined the Islamic banking products. Deposit, loan, currency exchange, bonds, valuable papers and metals, receive and payment orders and credit operations were analyzed according to the above usury and non-usury measures. Some products as Foroosh-e-Aqsati, Ijareh-be-Sharte-Tamlik, debt purchase and sale, and composite interest derived from inability of loanee (borrower) to repay the debt are usuric. And also giving loan facilities through non-interest loan, civil Mosharekeh, legal Mosharekeh, direct investment, Modharabeh, Salaf transaction, Jjiale, Mozaraeh, Mosaghat, Ijarah, according to specific conditions are non-usuric. In all of these products except non-interest loan and Ijarah, which the rate of Ijarah should be predetermined in advance, the interest rate must not be determined and conditioned, otherwise, the contracts become usuric. Foreign exchange operations in spot and swap transactions (in case of not-existing interest rate in exchange calculations), options (in case of unique interest rate for two currencies), letter of credit are non-usuric but the foreign exchange operations of futures and time-based transactions, timed swap transactions; options and foreign exchange deposits enter into usury realm. We examined all sale and purchase of bond papers, metals' transactions, receipt and payment order, and banking credit operations and their characteristics from usuric point of view.

The PLS bank is capable to handle non-usuric operations by distributing profit proportionate to the share of shareholders (depositors). In case of removing different deposits' differentials and increasing transparency and efficiency of banking operations, by removing the numerous deposit interest rates and increasing the participation of banks in economic activities and ability of both private and public legal or real persons will increase the efficiency of financial intermediary role of the bank and collecting and allocating financial resources.

### BRIEF SUMMARY OF THE INVENTION

The PLS banking is a banking/financial system/service with newly defined instruments/innovations of Mosharaka and Pazireh makes the banks/financial institution as an international firm which perform similar jobs as stock exchange markets for transactions of PLS products certificates through a secondary certificates market on virtual internet space.

In the PLS banking bank/financial institution would invest collected deposits into the finitude or endless projects based on Mosharekeh Contraction as either general or special attorney according to the depositor's desire (for type 1 and 2 products) or bank own choice (for type 3 products) and finally distribute the investment return among the depositors. Bank after deducting commission as being attorney or agent will assign the whole benefits come from investment to owners of money resources and performs her own intermediary function according to compiled instructions.

First, the entrepreneur refers to the PLS branches and offers her proposal to bank for doing a joint venture. She will be announced the participation conditions and regulations through information portal designed for PLS banking. Bank after evaluation of the proposal will introduce it to depositors. Depositors by purchasing Mosharekeh/Pazireh certificates allow the bank to use their deposits in participation into the approved project. The new financial instruments/innovations of Mosharekeh certificates for finitude projects and Pazireh certificates for endless projects are defined and used.

In the PLS a trustee/custodian (Amin) unit will supervise entrepreneur operations on behalf of the bank for watching good performing of the project, executive operations controlling in comparison with announced programs, resources allocation manner and optimized allocation of resources by using key indices and considering the financial statements and etc.

Secondary certificate market in cyber space for certificates transactions is established by bank. PLS banking system does not use fixed predetermined interest rate contrary to conventional banking system. All banks or financial institutions can use the PLS system.

### BRIEF DESCRIPTION OF THE SEVERAL VIEWS OF THE DRAWINGS

FIG. 1 shows: PLS Banking Architecture
In the PLS banking in addition to bank, depositor, entrepreneur, a new organizational pillar is required for practical structure of the PLS banking to handle over special duties for specific nature of partnership activities. In this new architecture, the functions of each unit will be different from what they are in the conventional banking.

FIG. 2 shows: PLS Banking Products and processes
PLS banking products are separated in two categories of finitude and endless projects.

FIG. 3 shows: The logical relation among PLS entities
Figure shows the operations for the entrepreneurs and the depositors.
The figure is divided into 2 pages.

FIG. 4 shows: Operation and Communication in PLS Banking Respecting to System Limitation Flowchart. This is expansion of FIG. 3 with deeper level details divided into 4 pages

FIG. 5 shows: Data Flow of PLS Banking Chart Level 2
Detailed expansion of FIG. 3 divided into 9 pages

### DETAILED DESCRIPTION OF THE INVENTION

### Executive Installation

We designed a new solution to fit nowadays needs with consistency for contemporary workflows in legal operational and IT aspects. The design of PLS BANK is as follows:

Disregarding the public or private ownership of bank, a solution whose interest rate could be determined according to the real sector return rate is required. Whereas the bank receives Haq-ol-Amal as intermediate of resources, (a fee to follow and care the depositors' rights and benefits by offering capital management services to depositor and supervising on the agent's (entrepreneur's) operations who do investment based on deposits of depositor(s).

The bank in position of an attorney or an agent or a representative of depositor receives capital management services fee of depositor and will transfer the investment returns (profit or loss) to the depositor as per related instructions. According to this new definition, the agent bank as public or specific attorney by using Mosharekeh contract can use deposited deposits in shape of Moshaa (joint) and/or based on the depositor's request in specific product (of type 1 or 2 below), or based on banks opinion (in product type 3 below) and invests in the project or projects and distribute the return of the investment among depositors. The profit and/or loss will be distributed amongst them according to the pre-written related instructions. In this relation the bank, does the task of financial intermediary and after deducting her wage, as attorney or agent will pay the depositors' shares to them. These operations are depicted in FIG. 3.

### PLS Banking: Specification and Implementation Method

Three following new banking products are the results:
1—Mosharekeh (sharing Profit and Loss) on specific projects
2—Mosharekeh (sharing Profit and Loss) on a basket of some projects
3—Mosharekeh (sharing Profit and Loss) on the profit and loss of the bank's branch who implement PLS banking.

### The Operational Sketch:

In a Jiala-based contract, bank will make a contract with depositors to allocate their deposits to one of the above three products according to their requests to get shares in profit and loss of the entrepreneur who implement the project. In other side of the bank, an entrepreneur has requested to make a contract with bank in a Mosharekeh-based contract. In this way bank operates as an intermediate that receive Haq-ol-Jialeh or Haq-ol-Amal fees and allocate the deposit resources of depositors to investors. Depositors in this case are considered as financers and investors are those who do the entrepreneurship of the investment. The profit and loss of this investment will be distributed among depositors, investors and bank. Bank, by offering this service can earn some share of profit/loss of these investment project as same as capital services management fees. In PLS banking, the contracts between bank and depositors and between bank and investors (entrepreneurs) can be performed based on Karmozd (wage) as well as sharing on profit and loss (similar to financers/depositors).

Entrepreneur is a legal person who combines her (cash or none-cash) capital with share of depositors in a Mosharekeh based contract through bank intermediary to arrange a joint investment.

Amin (trustee) is an institution who supervise the PLS process as representative of Bank about the good governance of the project, controlling the implementations according to the declared plans, allocation of resources, optimal use of resources, . . . by using key indicators and financial sheets auditing and etc.

In Profit and Loss Sharing (PLS) banking the new financial innovations as “Mosharekeh certificate” is to be used. The bank by issuing and offering the Mosharekeh certificates and creating secondary markets for transacting Mosharekeh certificates and designing baskets of Mosharekeh certificates will efficiently activate this type of banking and also the other related financial institutions.

Implementing these arrangements needs particular instructions. We designed and defined the necessary instructions and procedures to perform the job:

Mosharekeh (partnership) Certificate is no-name papers issued by PLS banking branch with specific nominal price for definite time (project implementation duration). Mosharekeh Certificate holders will share profit and loss of project prorated to their nominal price and time duration of their Mosharekeh (participation). The bank will deliver a certificate of Mosharekeh and/or receive a service fee for capital management services to depositors which will be according to one of the above three products. Mosharekeh Certificate holders can transact these papers through internet or bank counter in cyber environment and thus this certificate can be transacted internationally as a financial asset.

Pazireh (subscripted) Certificate has similar characteristics except it works for endless projects. That is for those projects, which after the end of construction phase enters to the production.

Depositors by accessing through information portal of internet station in secondary market of Mosharekeh/Pazireh Certificates or by going to one of the branches of the bank performing the PLS banking and by receiving the consultation of the bank experts in the information counter will be familiarized with different Mosharekeh products and their conditions and regulations for depositing. Then she will decide to select one of the products of the three mentioned PLS bank products. By making the contract and registration, the system will automatically issue the Mosharekeh/Pazireh Certificate and the Mosharekeh/Pazireh Certificate will be accessible for the depositor. At the end of Mosharekeh period (for the products 1 and 2 regarding a single project or a basket of projects), or at the end of the financial year (regarding Mosharekeh in profit and loss of the branch who perform the PLS), accounting/auditing counter by receiving the related information will calculate profit and loss of the project or basket of projects or branch and will distribute the profit and loss of the Mosharekeh and perform account clearing. For endless project, accounting/auditing counter again finalize the books and change the status of the project to a company and transfer the Pazireh (subscripted) Certificates as shares of the established company.

Entrepreneur also by going to the PLS banking branch will offer her investment Mosharekeh project to the bank. The bank by declaring the conditions and regulations of Mosharekeh to the customer through the information portal of bank's Mosharekeh/Pazireh Certificates or information counter located in the PLS branch pays a document fee (according to its instruction) and bank will receive the proposal of the project with detailed economic, technical and financial feasibility reports and other related information. Entrepreneur evaluation unit, according to the background of the entrepreneurs and according to specific instructions will evaluate the entrepreneur and in case of positive evaluation of technical ability and expertise of entrepreneur will send the related reports to the project evaluation unit. In case of positive evaluation of the project, project evaluation unit will determine the type and amount of collaterals, guarantees and Mosharekeh share according to the specified instructions. The arrangement will be transmitted to entrepreneur. After making contract the requested and approved resources will be paid to entrepreneur through the contracted Mosharekeh contract. The whole documents (according to related instructions) including: budgeting, timing plan, resource needs and resource consuming manner, project implementation, phasing, quality control, reporting, ending and delivering of the project should be delivered to Amin (trustee) of the project by entrepreneur. The reports of supervision on the project and the quality of performance of the entrepreneur should be delivered to the accounting/auditing bureau of the bank according to the predetermined time schedules. It is obvious that the reports of the Amin of the project will be the criteria of the following payments of the bank to entrepreneur. At the end of the project and according to the instructions and formulas, relating to the amount of profit and loss of the project and the Karmozd (wage) of the bank or her share will be calculated by the software of accounting/auditing bureau. The share of the entrepreneurs and the depositors will also be determined and will be transferred to their accounts. In the case of reports of Amin regarding stop or delay of the project, the amount of delay and the loss caused by delay will be calculated according to the given PLS accounting instructions.

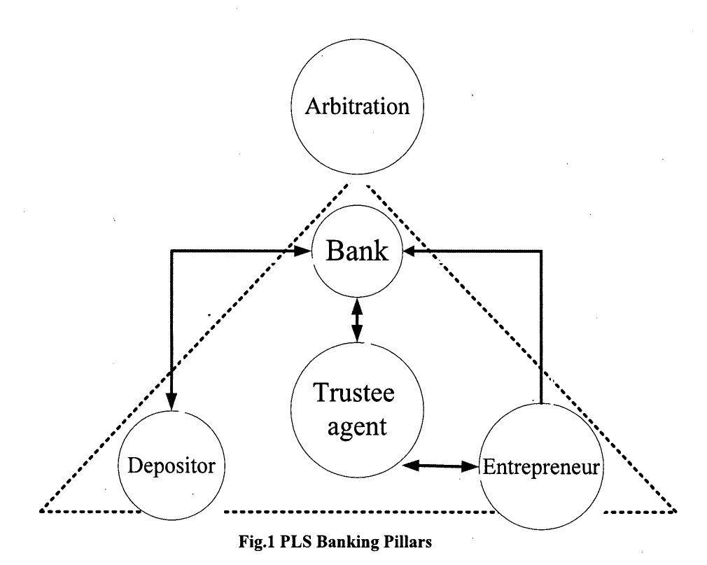

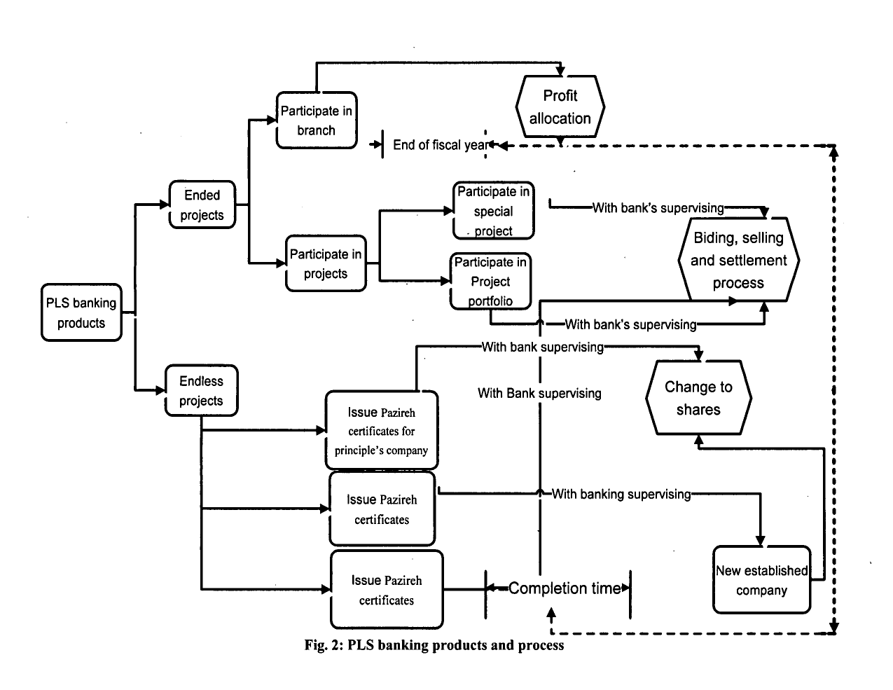

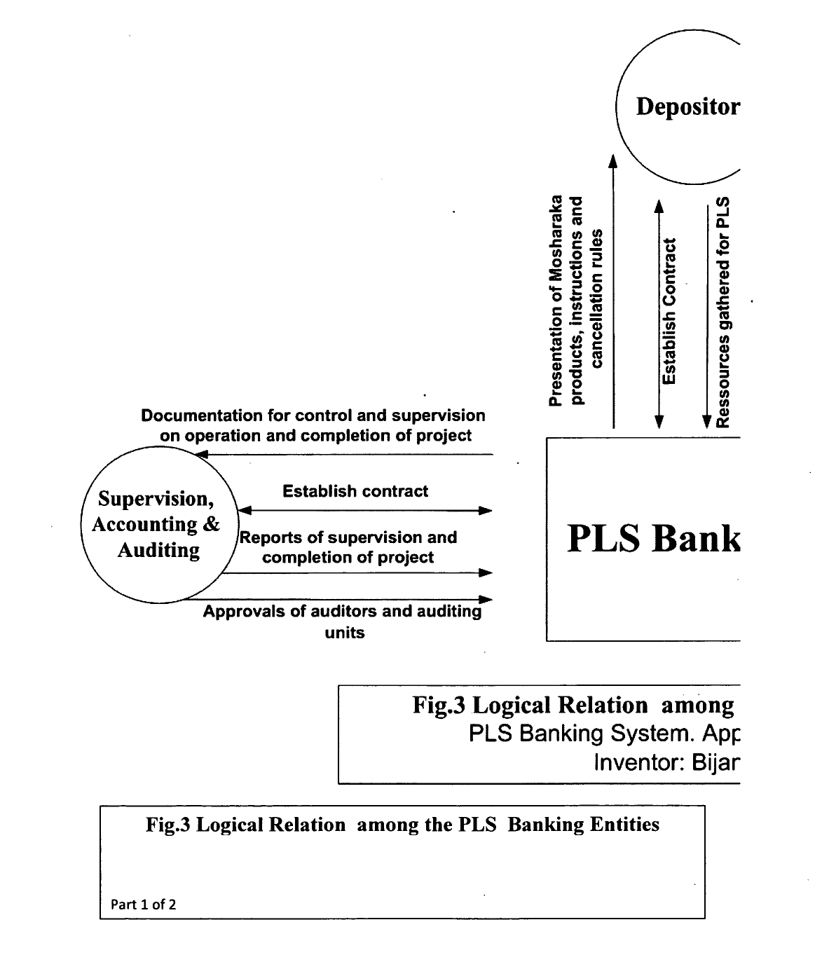

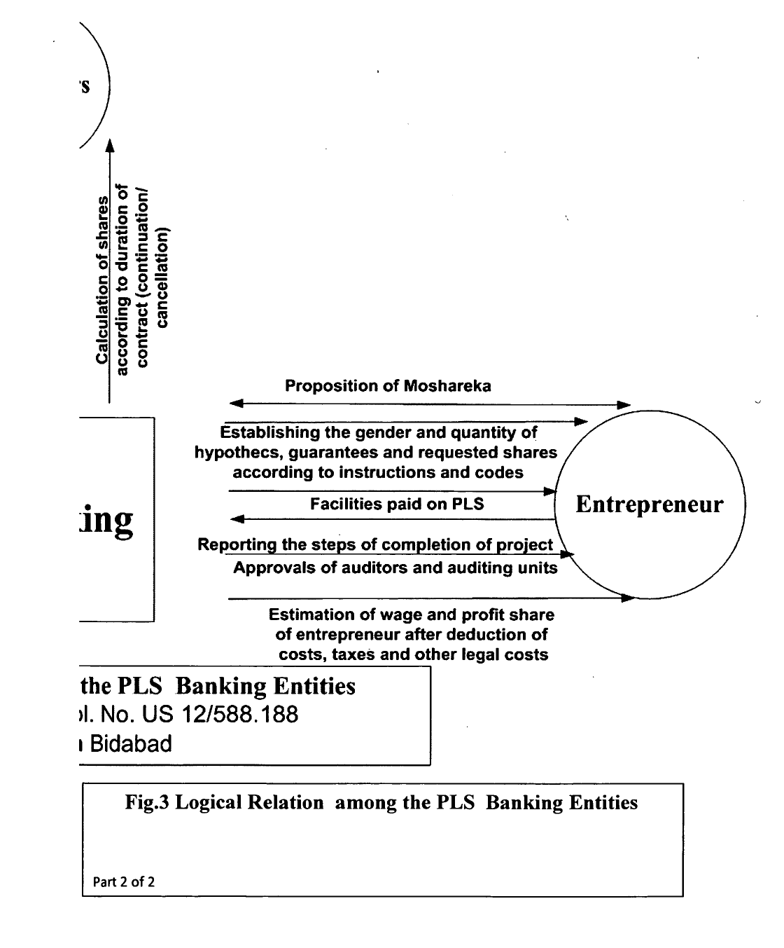

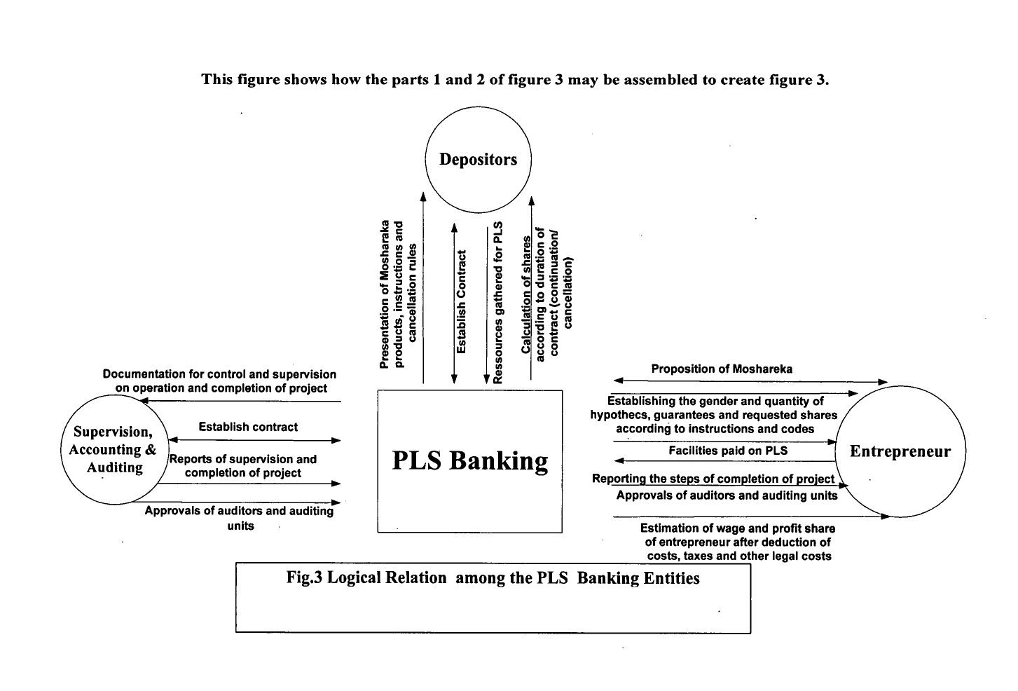

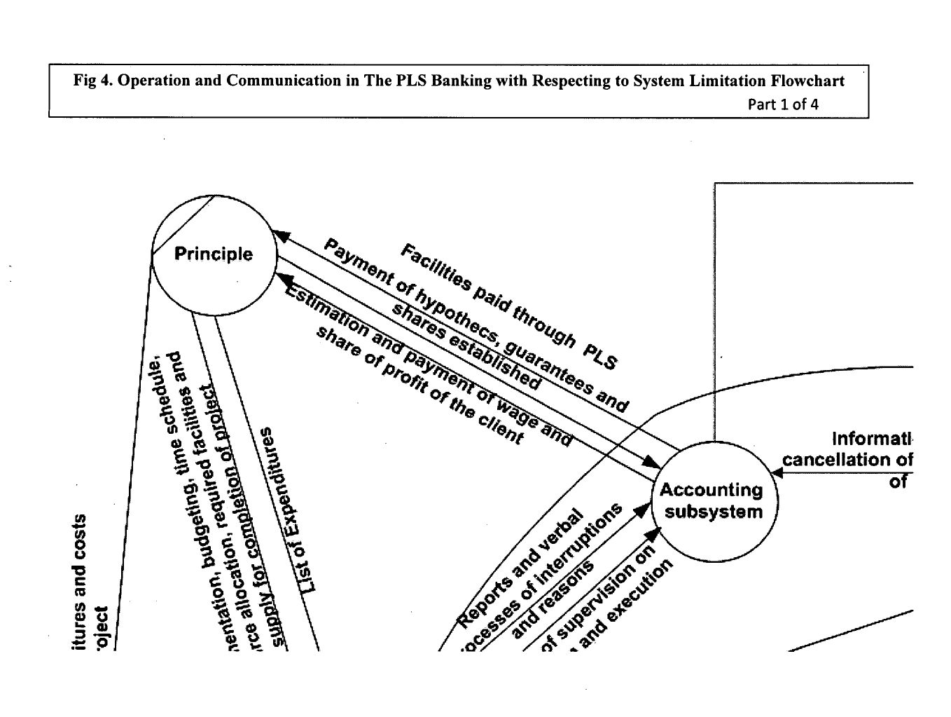

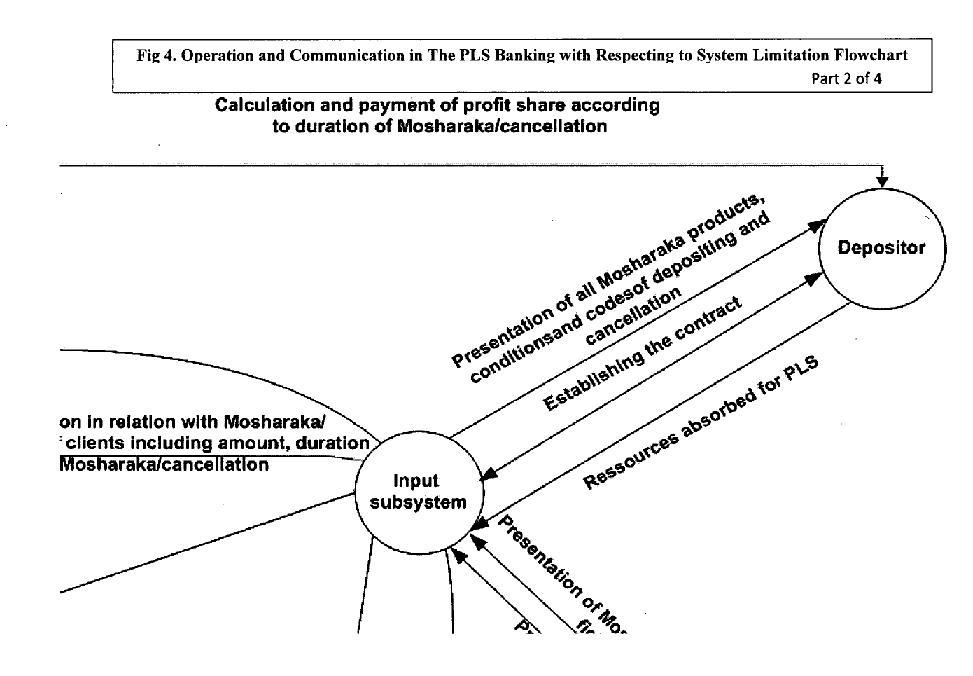

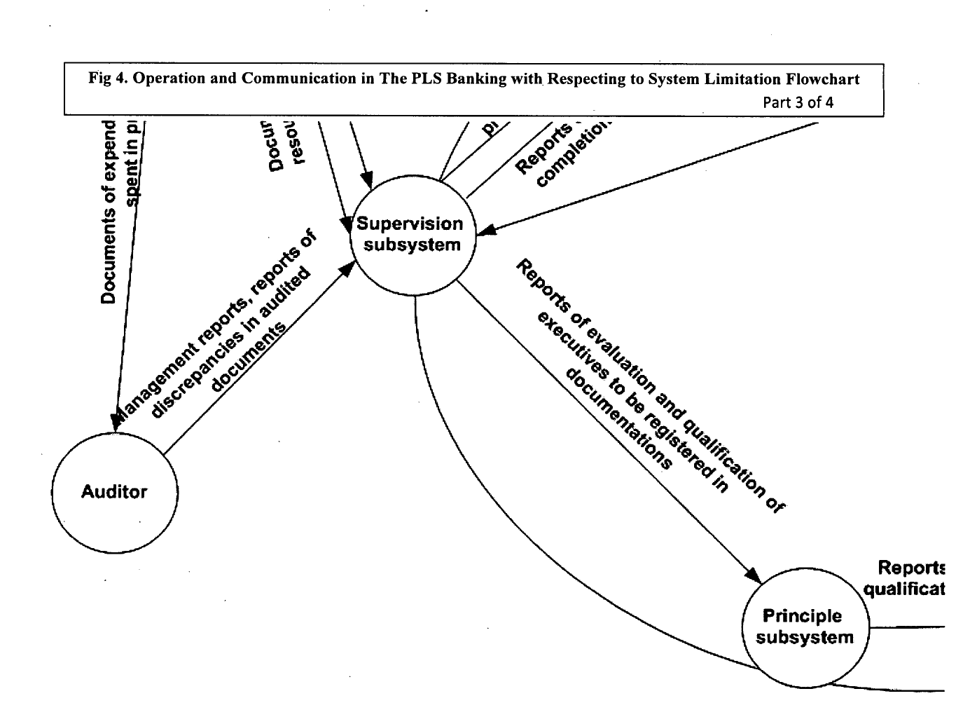

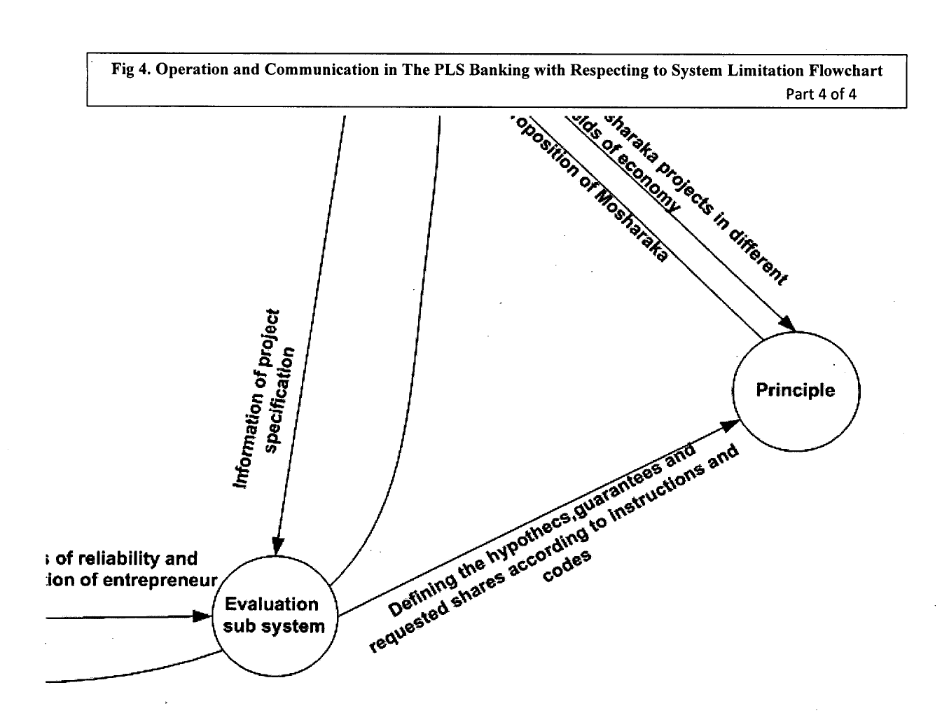

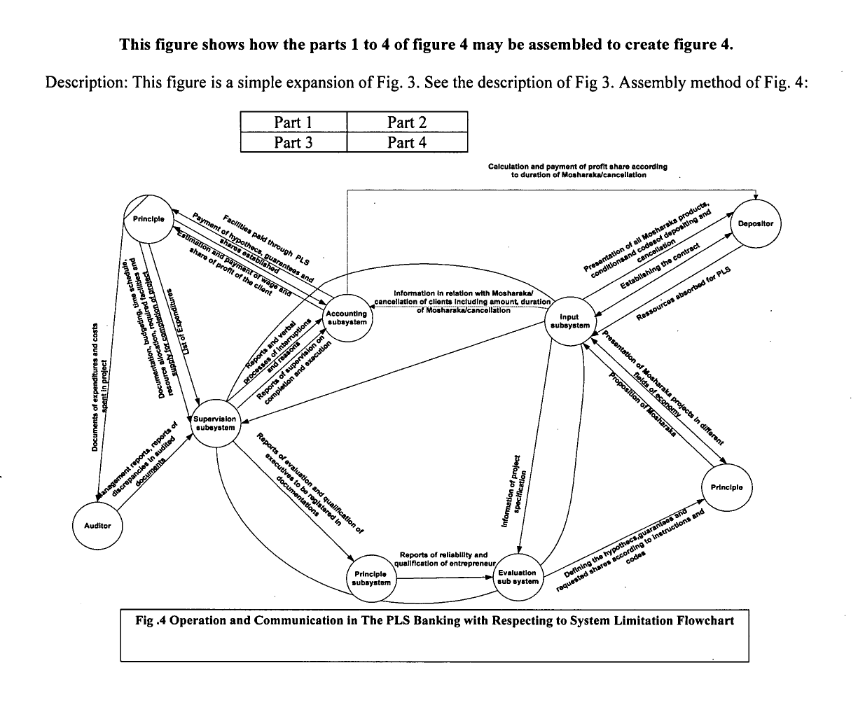

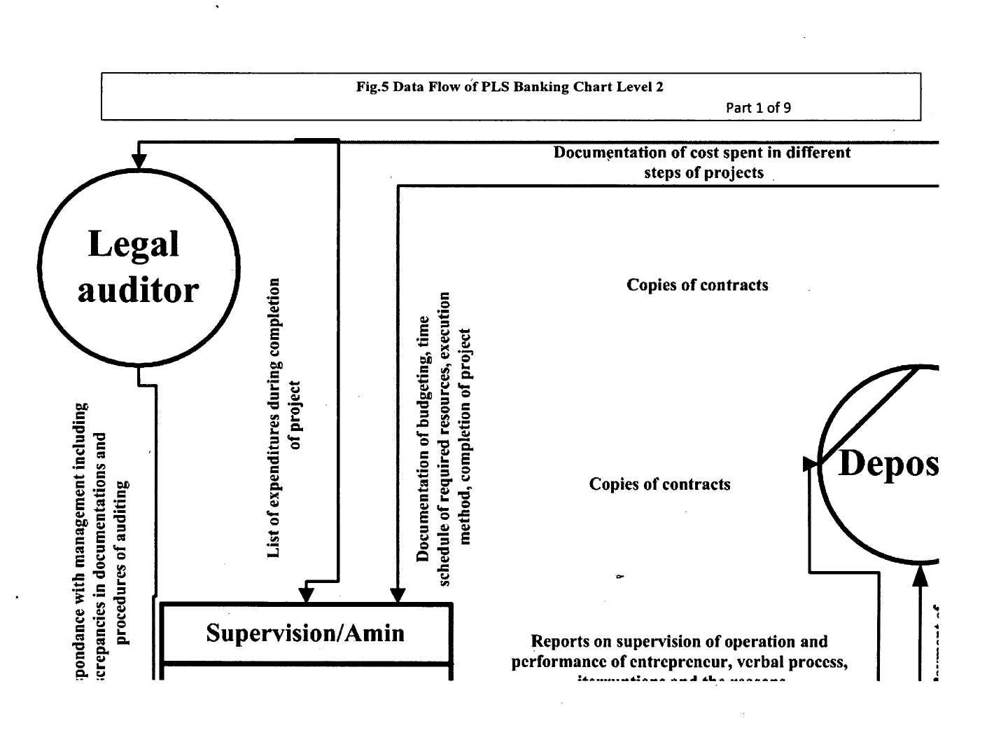

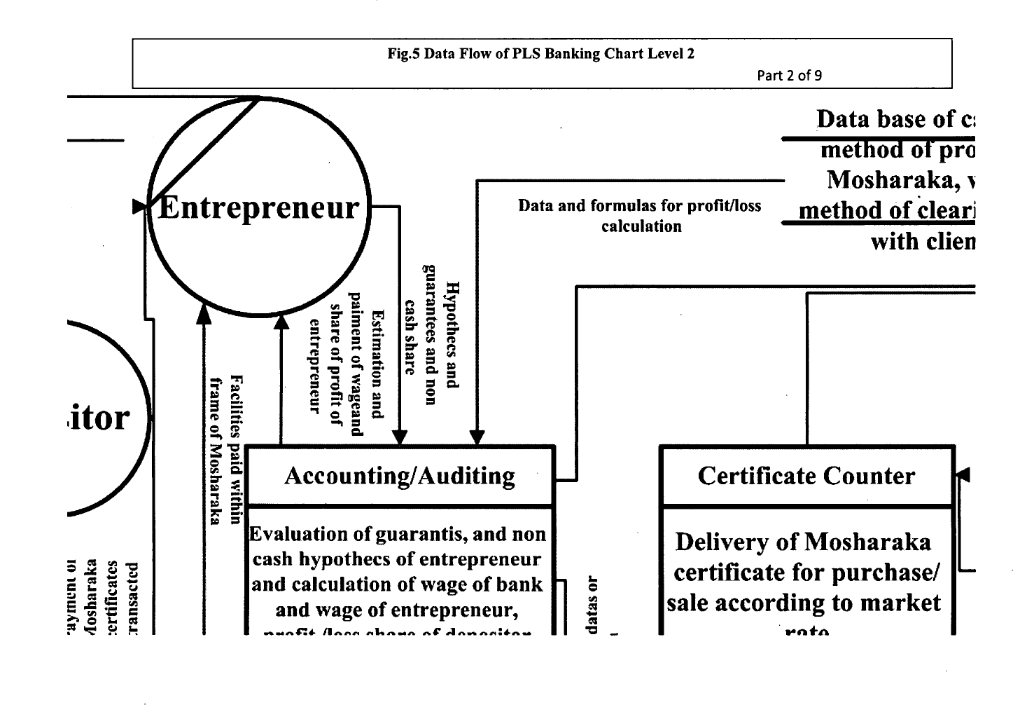

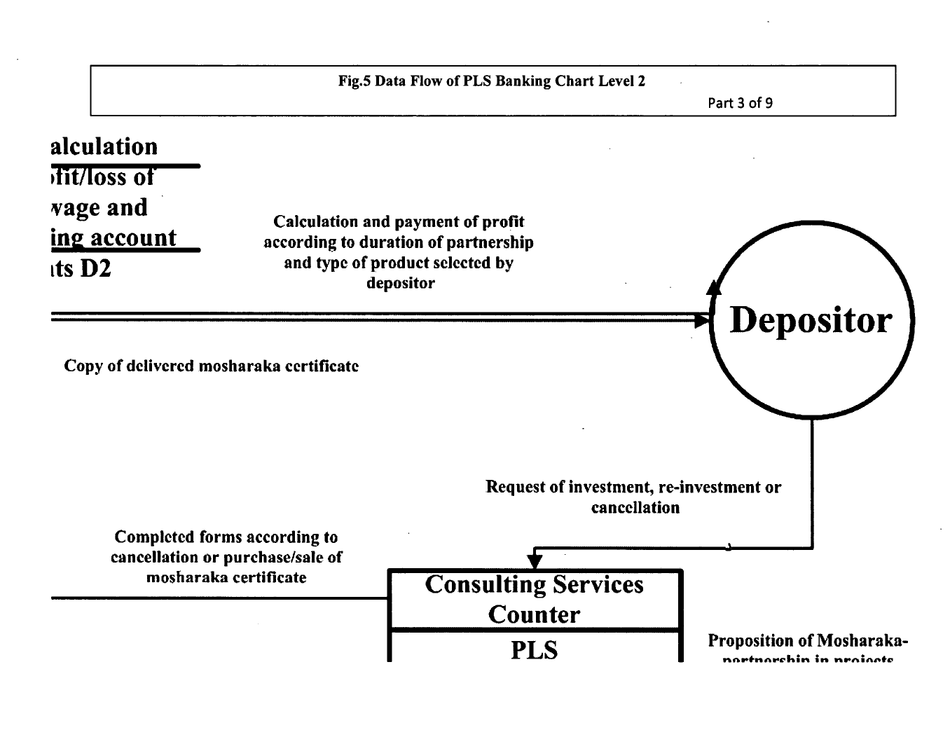

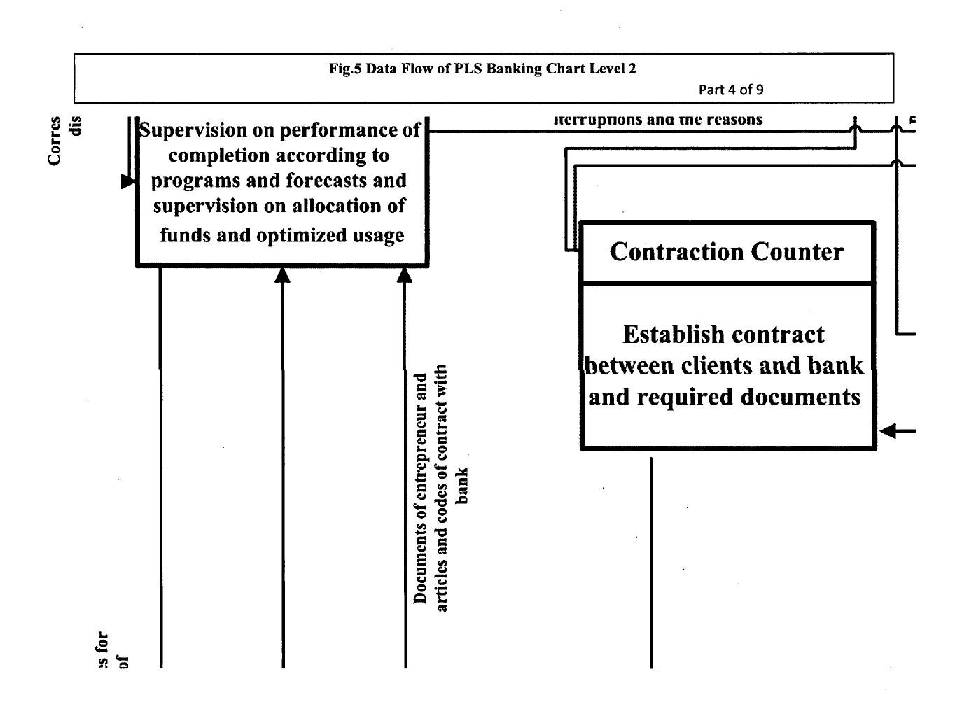

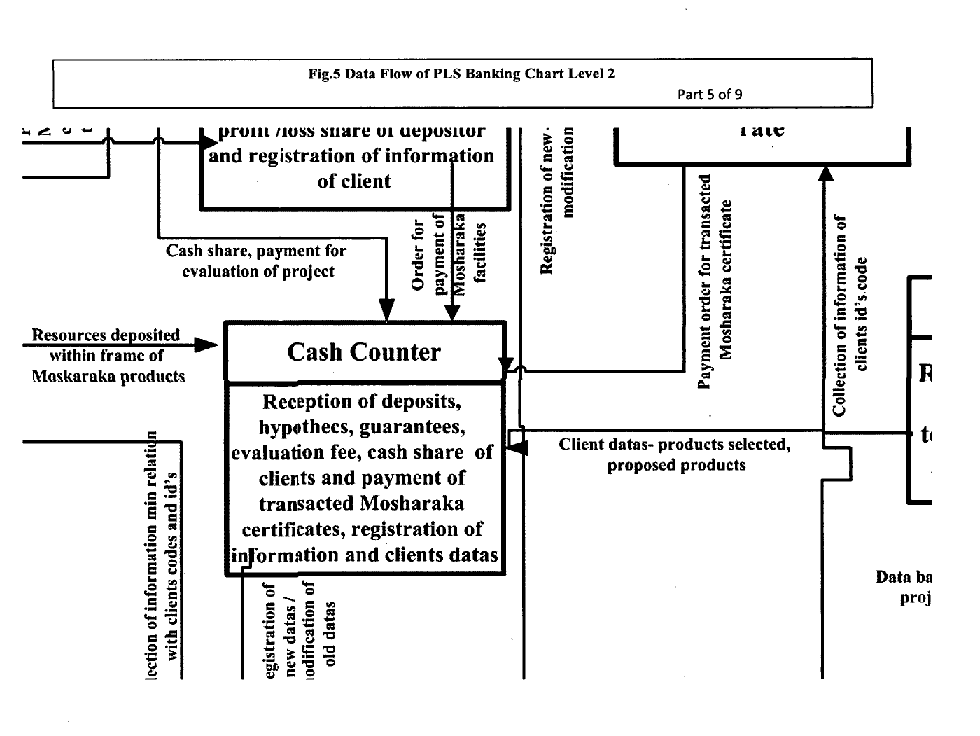

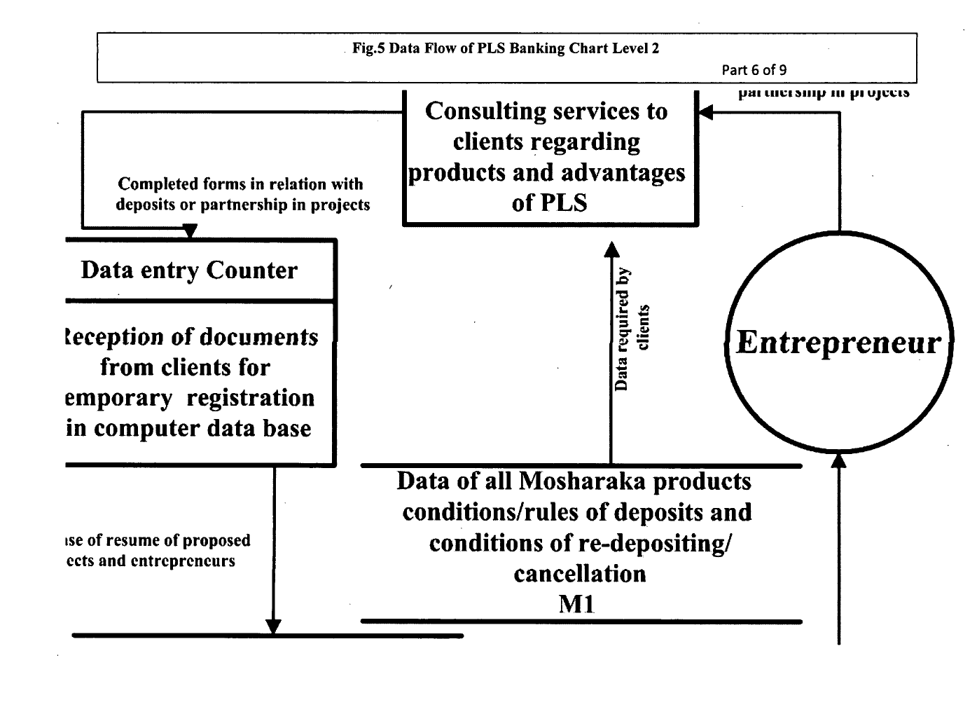

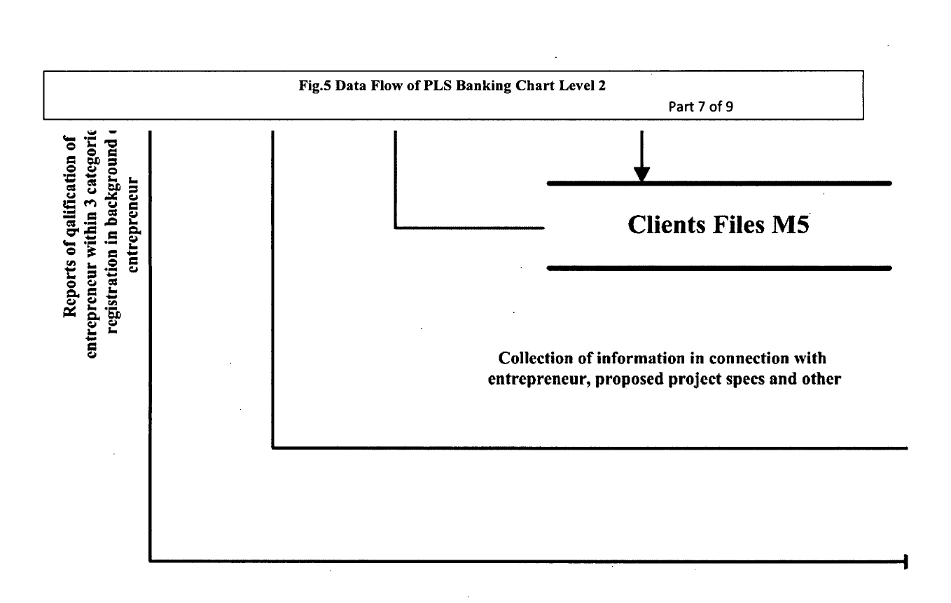

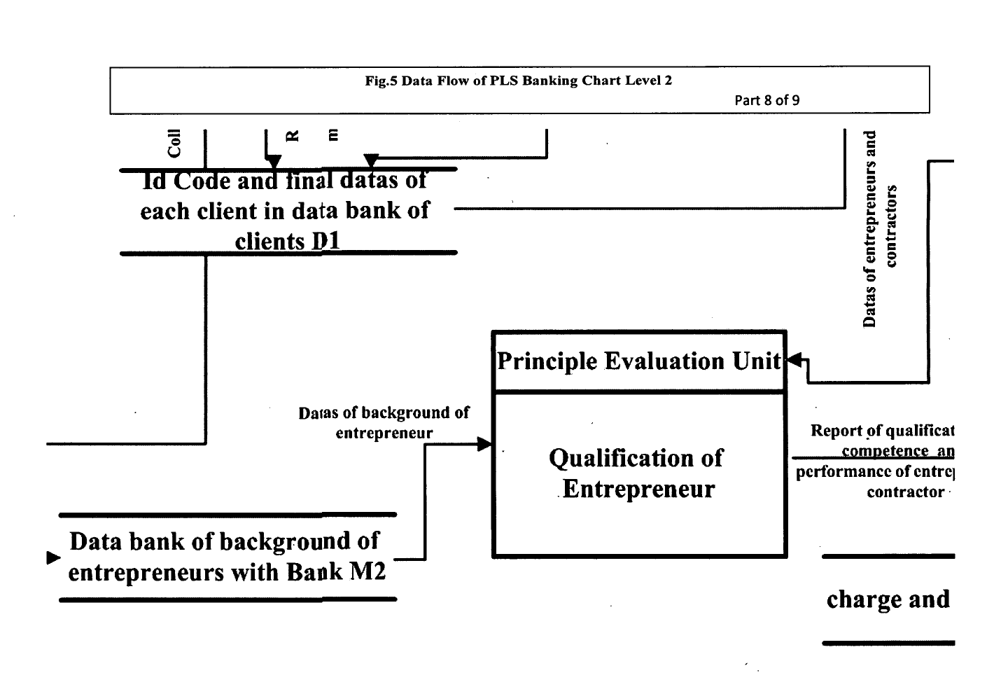

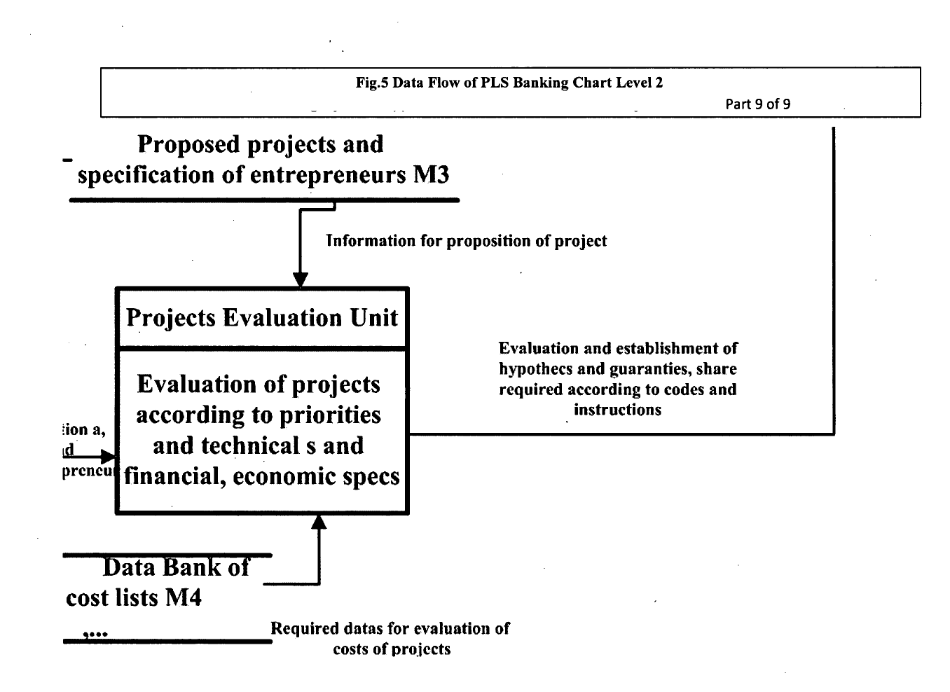

The whole operations may be depicted in different levels. As stated before, FIG. 3 shows a bird's eye view on operations among depositor, bank and entrepreneur. More detailed operations are shown by FIG. 4. And FIG. 5 is a schematic operational view in a more detailed scheme. The detailed scheme may also be tailored for different PLS banks in different situations to satisfy the specific needs.

Auxiliary financial instruments and innovations are about Mosharekeh/Pazireh Certificates Baskets regarding risk determination in economic activities and determination of the weights of economic activities in the basket; and classification of Mosharekeh Certificate Baskets; and Mosharekeh Certificate Insurance; and typical contracts and usable forms in PLS banking.

### PLS Banking Architecture

The foundation of the PLS banking bases on the keep getting benefit of economy real sector return for the whole participants of the economic activities. Therefore, the capital owners (shareholders), labor, services and technology suppliers and operators should get benefit proportionally on basis of their own portion and inputs. Fulfillment of this approach could be provided by the executive preparation of PLS banking. For designing PLS banking architecture, first of all each party or entity and its functions should be explained precisely. In addition to bank, depositor, entrepreneur (project handler and technical and executive knowledge owner) a new organizational pillars are required for practical structure of the PLS banking to be established to handle over special duties regarding to the specific nature of partnership activities, (see FIG. 1 for a schematic view of this proposition). In the new architecture, the functions of each unit will be different from what they are in the conventional banking, though their names are called as same as conventional banking units.

Bank: The bank as an authorized agent on behalf of the depositors allocates the deposit resources of depositors to approved applicants of the credit facilities according to specific contracts and distribute the investment return as profit or loss consequences among the depositors, bank, and entrepreneur. The bank contractions with each party could be made on basis of commission or profit and loss partnership. The bank as depositor's attorney or representative is obliged to protect the depositor's rights and must apply her complete own specialized powers for preserving depositor benefits.
Depositors: who is the supplier of financial resources, based on investment Joaleh contracts uses her financial resources to purchase certificates of participation (Mosharekeh Cerificate) for participation in Finitude projects or buy certificates of subscription (Pazireh Certificate) for participation in endless projects; in specific project or specific package of projects or profit and loss participation in the PLS bank branch, to participate in the profit and loss of the project (or financial product) according to her share.
Entrepreneur: is a legal entity that combines her own cash and non-liquid assets with the depositors' deposits as a joint owners (spooling) and bank intermediary to establish a joint venture activity.
Trustee (Amin): is a unit who takes over the responsibility of supervising on the PLS process on behalf of the bank about the quality of carrying out the project, controlling practical operations in compare with approved documented entrepreneur plan, benchmarking, entrepreneur resources allocation and quality of optimum resources allocations etc by applying key indices and verifying entrepreneur financial statements.
Arbitration (Hakamiyat): takes over resolving the disputes and conflicts among the bank, entrepreneur and depositors whose their financial relationship is based on PLS banking. In case of concordance of the parties, resolving of claim might be to a pre-approved third party judicial person/entity that is acceptable for parties in the conflict.
Secondary Market The secondary market is suggested for simplifying, progressing and to make Mosharekeh (partnership) and Pazireh (subscripted) certificates more attractive. Bank creates this facility that Mosharekeh (partnership) and Pazireh (subscripted) certificates can be legally be sold and purchased in the secondary market on the internet.
Consultants: The consultants take over the role of economic, financial and technical assessments in PLS banking. Complexity of some projects in view of the applied technology, use of hiring specialists in the area is doubtlessly inevitable.

### Interactions and Relations in PLS Banking

The relation among essential pillars of PLS banking is shown in FIG. 1. Based on this method apart from the bank is private or governmental, interest rate of bank's facility will be determined according to real investment return. Bank as fund intermediary gains wage or commission as attorney or agent of the depositor and the rest of investment return will be paid back to depositors as profit or loss consequences. Accordingly, bank according to participatory investment based on general or special attorney contracts invests deposits collectively based on diagnosis of the depositor (in product 1 and 2) or on her diagnosis (for product 3) in the desired projects/plan and distribute the investment outcomes among providing depositors.

In the first step of PLS operation, entrepreneur presents her proposal and required documents and feasibility study regarding economical, financial and technical aspects of his project/plan according to compiled instructions in PLS banking instruction set. The entrepreneur delivers all required official letters and documents to the bank according to related bank compiled instructions including budgeting, time schedule, size of necessary resources and resource allocation manner, qualification of carrying project, phasing, quality management, reporting, project completion manner, specification of completed project quality. . . . The bank in case of necessity when the project contains special, complex or high technology and the bank's specialists are not able to evaluate and make supervision on the project will outsource the project evaluation and supervision as well to other consultants for evaluation and/or supervision. The bank in case of positive evaluation on both entrepreneur and proposal will publicizes project to interested depositors for participating of depositors according to specified PLS banking products for financing the projects. The depositors would buy the Mosharekeh (partnership) certificates or the Pazireh (subscripted) certificates and donate deposits to the bank and the bank allocates monetary resources to the suggested projects by empowering the entrepreneur to start the project. Trustee (Amin) supervises and controls the operations of entrepreneur directly on behalf of the bank for whole the process. Obviously, reports of the trustee will be considered as main criterion for next payments to entrepreneur from the bank. After completing the project according to the related instructions and predefined PLS accounting formulas, the portion of profit or loss consequences and the bank commission/wage portion will be calculated by accounting and auditing department. The portions of entrepreneur, depositors and bank will be determined and are transferred to their accounts. In case of existence of any reports on the interrupt ion of operations of the project from the trustee side, the amount of delaying losses will be computed and determined according to the related instructions.

The PLS banking products as Mosharekeh (partnership) and Pazireh (subscripted) certificates are issued by PLS bank under the central bank general approved PLS regulations and the certificates will be supplied to the depositors. The depositors could sell them at the secondary market before the due settlement time in case of revoking to cancel their depositing activity. They can do this via bank's electronic portal on internet or bank's transaction counters. Insurance company collaborations to hedge the certificates have been observed in this kind of banking.

### Legal Requirements

Lack of executive experience necessary for this type of banking cause new regulations and development of new guidelines. The first step should be in the form of necessary upstream regulations and rules to be issued by the central bank if there is a lack of regulations or guidelines within the banking industry for this kind of banking financial tools such as participation certificates and subscripted certificates for their legal protections.

### Components

Generally, the components of the PLS banking could be classified as following items:

Products and Services
Finitude projects
   Mosharekeh (partnership) certificates for profit and loss sharing on a special project.
   Mosharekeh (partnership) certificates for profit and loss sharing on a projects portfolio.
   Mosharekeh (partnership) certificates for profit and loss sharing on a PLS bank.
Endless projects
   Pazireh (subscripted) certificates to shares

Customer groups
Depositors
   Real entity
   Legal entity
Entrepreneurs
   Legal entities (private, governmental)

Financial instruments
Insurance agents
Portfolio management of Mosharekeh (partnership) and Pazireh (subscripted) certificates.
   Minimum risk and return
   Middle risk and return
   High risk and return
Certificates insurance with avoidance from
   Moral hazard
   Adverse selection
   Asymmetric information
Executive insurance
   Responsibility insurance
   Project's place insurance

Mechanism and specification of Mosharekeh/Pazireh IT based transactional system
Information system
Buying/selling of Mosharekeh/Pazireh certificates as remote
24×7
Multi languages
Multi currencies
Integrated
High secured
Privacy

Contractions
Depositor
   Jualah
   Wakalah
   Solh
Entrepreneur
   Mosharekeh
Consultant (assessment, trusteeship)
   Jualah

Office infrastructures, organization
PLS Strategy committee
Interpretation and revising of PLS regulations and process specialist group
PLS office including following department
   Legal department
   Project evaluation including following specialist:
      Economic
      Financial
      Technical and engineering (Back office)>
   Auditing department
   Financial engineering management
   Trustee (Amin)
      Financial
      Technical and engineering
      Legal
   PLS branch (front office)>
   Information (consulting services)>
   Cashier
   Mosharekeh/Pazireh certificates transactions
   Others

Typical contracts including:
Contraction with entrepreneur
Contraction with depositors
Contraction with trustee (Amin)
Evaluation contraction

Instructions
Documents and required papers
Entrepreneur ability reaching
Justification reports
Accounting and auditing
Guarantees, collaterals and inputs
Banks returns
General condition of contraction
Set out the contraction
Standards and requirements for supervision
Trustee (Amin) competency
Entrepreneur reporting
Mosharekeh/Pazireh certificates transactions
Mosharekeh/Pazireh certificates swapping
Time schedule variation
New partnership
Depositor cancellation
Settlement
Arbitration
Force major

### Instructions

For fulfillment of the PLS banking, operational methods will be performed by the following compiled instructions:
1. Guarantees, collaterals and inputs: Depend on the entrepreneur classification (green and yellow groups) the collateral will be taken in different types of collaterals and guarantees for good performance. The input portion of entrepreneur including cash or non-cash in each category is determined by this instruction.
2. Required documents for project evaluation: All the required financial and non-financial documents for project evaluation and legal and performance authorizations are determined by this instruction.
3. Entrepreneur reporting: The reports to the bank, trustee, inspector or other controlling authorities are determined in this instruction.
4. Feasibility reports: The main purpose of this instruction is to organize and standardize the economical, technical and financial feasibility studies of the project till the affiliated departments can evaluate the mentioned documents according to the specified framework.
5. Arbitration (Hakam): The condition of referring conflicts among parties (depositors and entrepreneur with bank) to a pre-accepted third person/s is determined in this instruction.
6. Force major: Coming up unexpected events for beneficiaries of the PLS banking are to be handled by this instruction.
7. Instruction for revocation of depositors to cancel her deposit before due date: Revocation of depositors to cancel her deposit for not carrying on the investment and the settlement manner for the cancelation by selling Mosharekeh and Pazireh certificates is specified in this instruction.
8. Time schedule and expense deviations: In case of coming up deviations, either in time schedules or expenses plan of the projects coming from either fault or delinquency of the entrepreneur or affect of inflation in calculation of costs of entrepreneur and also the manner of calculation of share of beneficiaries in these circumstances are specified in this instruction.
9. New partnership: In case of extended financing of PLS projects, issuance of new Mosharekeh and Pazireh certificates would be according to this instruction.
10. To settle with entrepreneur: The settlement terms and manner with entrepreneur is specified in this instruction.
11. Pazireh certificates swapping: To change Pazireh certificates to shares and the related processes and valuation of shares are specified in this instruction.
12. Mosharekeh and Pazireh certificates transactions: The Mosharekeh and Pazireh certificates transactions on internet and establishment of secondary market and market management are specified in this instruction.
13. The entrepreneur ability: Including the points regarding to technical and financial capability and qualification classification of the entrepreneurs based on the different projects, collaterals types and guarantees for good performance, fulfillment of obligations, the share of entrepreneur, entrepreneur partnership inputs and entrepreneur classification to three categories of green, yellow and read.
14. Trustee (Amin) competency: specification and competency of trustee as supervisor agent to supervise the entrepreneur performance as real persons or legal entities are described in this instruction.
15. The standards and supervision obligations: This instruction takes over the whole obligations and required standards for supervisory processes.
16. General conditions of contraction: To regularize proper contractions and making contents of contracts obligatory and legally mandatory for each party in the PLS banking this instruction is to be used.
17. Contracts compilation: Typical compiled contracts of the bank with entrepreneur, depositors, trustee (Amin) and consultants of the project have been brought in this instruction for each type of PLS banking products including finitude and endless projects.
18. Accounting and auditing: The requirements and obligations of auditor, auditing process, financial statements of entrepreneur's company, and documents verifying to confirm the accuracy of the operations of entrepreneur are cited in this instruction.
19. Bank gains: Gains of the bank in all processes of primary and supplementary evaluations, supervisory services, trustee (Amin), financial engineering, auditing and the other services and also the bank's wages and commissions have been specified in this instruction.

### IT Infrastructures

Based on the previous researches, one of the important reasons to not prevailing PLS banking is lack of integrated systems, which able the bank to connect whole producers of information resources together and every transaction will be traced and supervised through them. Therefore, for achieving to the ideal PLS condition it is necessary to integrate different systems including Enterprise Resource Planning (ERP), and Islamic core banking containing other modules and subsystems like Customer Relationship Management (CRM), Supply Chain Management (SCM), Manufacture Executive System (MES), Human Resource Management (HRM), Business Process Reengineering (BPR), Workflow management (WFM). But this solution is for as an ideal PLS. Since integrated core banking necessities for this type of PLS banking is not available yet so it is not possible to apply this integrated PLS banking as full automatic banking and leave this idea for the future extension of PLS.

The applied technology in this phase is web based secondary market portal for Mosharekeh and Pazireh certificates, which it will be applicable through the internet connection and can be connected to the personal accounts in the bank. The individuals or the certificate's owners become able to deal these kinds of digital papers (certificates) through the internet based communication networks. Therefore, these certificates as an asset can be negotiated and traded over the world on the internet. Generally, the PLS banking products specifications have been shown in table 1. The attractiveness of the products will be increased through the internet-based transactions on virtual secondary market on the internet.

### PLS Banking Products

According to table 1 the designed products and services in the PLS banking are separated in two categories of finitude and endless projects. The bank will get commission for supplying some financial management services such as making confidence among the depositors, supervision, financial engineering, project management and also transparency in the whole PLS products to depositors.
The finitude projects partnership: In this category of the PLS banking products, the investment return will be allocated and settled among the depositors, entrepreneur and bank at the end of the fiscal year (for product type 3) or after the ending time when the project will be finished and sold—depending on type of project. The products used can be a special project or a basket of projects. The applied financial instruments in these products are Mosharekeh certificate so that after depositing of depositor in a project immediately Mosharekeh certificate will be delivered to the depositors.
The endless projects partnership: According to FIG. 2 the bank will subscribe the shares in form of issuing Pazireh (subscripted) certificates for financing an endless project. The Pazireh (subscripted) certificate is similar to Mosharekeh (partnership products) certificate and can be transacted at the secondary certificate market. After ending the construction period and when the project is ready to start the exploitation period, the Pazireh certificates will be transformed into the shares of the corporation. The whole subscriptions process, exchanging Pazireh certificates to the share papers will be performed under the bank supervision and decisively the project ownership will be assigned to the depositors through changing their Pazireh certificates to the shares and after this transformation, the depositors will become company shareholders.

Bank might do the whole transforming process through changing Pazireh certificates owners to shareholders by establishing a new company (and not the entrepreneur constructing company) at the end of construction period and at the beginning of exploitation period. Bank might sale the shares of the Pazireh certificates owners in bidding and after deducting the entrepreneur and the bank portions pays cash to depositors.

### The Mosharekeh and Pazireh Certificates

The two important financial instruments of PLS banking are The Mosharekeh and Pazireh Certificates.
Mosharekeh certificate is an anonymous (digital) paper that is issued with specified nominal price for specific duration (performance duration of the finitude investment project) by the branch of the PLS bank. The owners of the papers participates on investment return in proportion to nominal price and duration of being as partner in the project and the bank will earns commission in lieu of supplying capital management services to depositors that are offered by depositors for investing their money resources in the PLS banking products.
Pazireh (subscripted) certificates is an anonymous (digital) paper is issued with specified nominal price and durations (performance duration of endless investment project up to the end of construction period) by the branch of the PLS bank. The owners of these papers will be owner of the company of the project in form of shareholders in proportion to their nominal price of their certificate and duration of partnership.

According to table 1, anonymity, transformability to others, transactablity in virtual secondary certificate market and in stock exchange markets, commission return of transactions for the bank (0.0005 from each transacted parties—seller and buyer), demand and supply (market mechanism) based price determination on internet secondary market, and final settlement with the final authenticated certificate owner are some of the attractive specifications for both Mosharekeh and Pazireh certificates. The main difference between Mosharekeh and Pazireh certificates is in finitude and endless nature of the projects. In case of Mosharekeh certificate, the settlement process will be done at the end of construction period by bidding and selling project. In case of issuing Mosharekeh certificate for partnership in the PLS branch's profit (product type 3), the settlement process will be done at the end of fiscal year when the PLS branch's financial statements are finalized. In the case of Pazireh certificate, the bank undertakes to change Pazireh certificates owners to shareholders of the investment project and there is no responsibility for PLS bank to pay back the depositors and entrepreneur and responsibility of the bank will be finished after completing the above transformation. The process for final settlement of Mosharekeh and Pazireh certificates in finitude and endless projects is shown in the FIG. 2.

TABLE 1
The PLS banking product and services framework

| | Settlement time | Type of | | Mosharekeh and Pazireh certificates |
|---|---|---|---|---|
| Products | Profit/loss | contracts | Financial hedging | specifications |
| Special | Completion of | Jualah | Insurance of some | Anonymity |
| project | construction and | Wakalah | portion of the | Transformable to others |
| (finitude) | selling the | Solh | value of the | Transactability in virtual Internet-based |
| | constructed project | | projects can be | secondary certificate market and on the |
| Basket of | Completion of | | arbitrarily applied | bank counter and stock exchange in a |
| Projects | construction and | | Other insurance | mechanized IT-based state. |
| (finitude) | selling the | | instruments as | Earning commission from the both |
| | constructed project | | responsibility | transactor parties per transaction. |
| Participation | At the end of fiscal | | insurance, | Valuation of certificates based on |
| in PLS | year | | engineering | demand and supply mechanism. |
| branch's | | | insurance and | Transformation possibility of Pazireh |
| Profit and | | | accident insurance | certificates to shares in endless |
| loss | | | have been defined | projects. |
| (finitude) | | | in different related | Decisive final settlement with the lastl |
| Endless | Completion of | | contracts to hedge | Mosharekeh certificates owners. |
| projects | construction period | | the project | Customer groups can be private or |
| | and at the beginning | | execution | governmental, real persons or legal |
| | of exploitation | | | entities. |
| | period | | | |

### PLS Banking Customers Groups

According to this banking framework, the customers can be categorized into two groups of depositors and entrepreneurs of investments projects as follows:
Depositors: Depositors in PLS banking could be real person or legal entity and either private or governmental.
Entrepreneurs: Entrepreneurs in PLS banking necessarily must be a legal entity/corporation either private or governmental. Legal entity specification for the entrepreneurs is necessary for auditing financial documents and statements that causes reliable and more transparent calculation for profit or loss calculations.

### Islamic Contracts In PLS Banking

Bank on basis of Jualah contraction, arranges a formal agreement with depositors so that according to depositor opinion provide partnership in entrepreneur's investment. In other side, bank based on Mosharekeh contract (based on Civil Participation contraction) will be entered into interaction with entrepreneur. By this contract, the bank will do as an intermediate entity and gains Haqh-aljualah (wage) from depositors and mobilize financial (deposit) resources entrepreneur. Finally, investment returns portion for depositor will be transferred to the resources suppliers (depositors) based on the agreements of the contract. The Solh (peace pact) contract is needful beside of the Jualah contraction as necessary for simplifying Mosharekeh and Pazireh certificates transactions on the internet-based secondary certificate market for depositor approval and her signature.

### PLS Banking Instruments

In PLS banking, the new financial instruments and innovations as Mosharekeh and Pazireh certificates are applied. By PLS banking, bank increases the efficiency of monetary and financial markets and by issuing Mosharekeh and Pazireh certificates and establishing secondary certificate market and designing Mosharekeh certificate basket/portfolio will play an important role in mobilization of resources. Performing the mentioned specifications of PLS will facilitate domestic and international customers to enter the PLS based depositing and investment simply.

The other complement financial instruments will be separated into Mosharekeh certificate basket/portfolio, issuing and applying insurance products for covering probable risks. Relation between risk and return in investment and financial activities and covering the whole customer groups' requirements in view of the risk-acceptability, the classification of the PLS banking products is important. Therefore, for decreasing risk in the PLS banking products, the certificates can be classified in following portfolios:

Mosharekeh certificate portfolio with low risk and low rate of return

Mosharekeh certificate portfolio with a medium risk and medium rate of return

Mosharekeh certificate portfolio with high risk and high rate of return

For insurance encouraging and supporting of capital owners and decreasing different risks among them as moral hazard, adverse selection and asymmetric information the bank can establish an organization to provide necessary supports. For avoidance from falling in moral hazard in side of the capital owners it is required that a portion of customer's principle of capital be covered by insurance coverage. The coverage may be around 50% of the deposited capital. This insurance is arbitrary and might be supplied by bank or other insurance corporations and purchased by depositors

### Organization of PLS Banking

The organizational structure of the PLS banking with paying attention to the above definitions might be designed in form of PLS banking strategy committee, PLS banking specialist group, PLS department, legal department, project evaluation department, auditing department, financial engineering management department, trustee (Amin) and PLS branch in which the latter is designed to have information, consulting services and cashier sections.

### SUMMARY AND CONCLUSIONS

The PLS banking is a banking system with newly defined instruments of Mosharaka and Pazireh that not only stabilizes the financial and economic markets by preventing the banks, loanees (borrower)/entrepreneurs and design, construction and contractor sectors in the economy from bankruptcy during crisis periods and volatile markets, but also makes the banks as an international firm which perform similar jobs as stock exchange markets for transactions of PLS products certificates through a secondary certificate market on virtual internet space. Depositors will earn more stabilized benefits too.

In the PLS banking apart from the bank is either governmental or private, the interest rate is determined by real sector and bank as financial intermediary gets commission as an attorney or agent of depositors and will transfer the remaining investment return either profit or loss consequences to depositors. Bank would invest collected deposits into the finitude or endless projects based on Mosharekeh Contraction as either general or special attorney according to the depositor's desire (for type 1 and 2 products) or bank own choice (for type 3 products) and finally distribute the investment return among the depositors. In this regard, the bank after deducting commission as being attorney or agent will assign the whole benefits come from investment to owners of monetary resources and do perform her own intermediary function according to compiled instructions.

First, the entrepreneur refers to the PLS branches and offers her proposal to bank for doing a joint venture. She will be announced the participation conditions and regulations through information portal designed for PLS banking. The related evaluation fee will be taken from the customers and projects specifications including proposal, economic, financial and technical feasibility documents of the project will be taken from the entrepreneur.

Bank after evaluation of the proposal will introduce it to depositors. Depositors by purchasing Mosharekeh/Pazireh certificates allow the bank to use their deposits in participation into the approved project.

In the PLS a trustee (Amin) unit will do supervision on entrepreneur operations on behalf of the bank for watching good performing of the project, executive operations controlling in comparison with announced programs, resources allocation manner and optimized allocation of resources by using key indices and considering the financial statements and etc.

In the PLS banking, the bank will used new financial instruments and innovations of Mosharekeh certificates for finitude projects and Pazireh certificates for endless projects. Secondary certificate market in cyber space for certificates transactions is established by bank. The whole operations will be done according to the compiled instructions. The PLS banking organization was designed according to the above definition in form of committees, units and departments.

As long as the PLS bank as a financial intermediary does not operates as conventional banks and receives wages from depositors for financial services she provides, will not meet bankruptcy in crisis.

As the rate of benefit of depositors is dependent to real rate of return of the economy, depositors benefit increases through PLS banking.

In period of crisis, the entrepreneurs of investment projects are more protected from bankruptcy; consulting, contractors and constructors industry are not subject to serious financial defeats with PLS banking.

The financial and economic markets meet stability through PLS banking.

Financial innovations of Mosharakah and Pazireh certificates make the bank act as an international portal performing similar jobs to a stock exchange market for transaction of PLS products certificates that can easily allocate and reroute resources to investments.

We hope this idea will serve the entire humanity and contribute to increase of wealth and abundance in the entire globe.

### Description of FIG. 1

### PLS Banking Architecture

In the PLS banking in addition to bank, depositor, entrepreneur, a new organizational pillar is required for practical structure of the PLS banking to handle over special duties for specific nature of partnership activities. In this new architecture, the functions of each unit will be different from what they are in the conventional banking.
Bank: The bank on behalf of the depositors allocates his deposit resources to approved applicants of the credit to entrepreneur.
Depositors: Is the supplier of financial resources, allocating her financial resources to purchase of certificates of participation/subscription.
Entrepreneur: is a legal entity that combines her own cash and non-liquid assets with the depositors' deposits as a joint owners (spooling) and bank intermediary to establish a joint venture activity.
Trustee (Amin): is the unit responsible for supervising process on behalf of the bank, controlling the quality of carrying out the project.
Arbitration (Hakamiyat): For resolving the disputes and conflicts among the bank, entrepreneur and depositors.

### Description of FIG. 2

### LS Banking Products and process

PLS banking products are separated in two categories of finitude and endless projects.

The finitude projects partnership: In this category the investment return will be allocated and settled at the end of the fiscal year (for product type 3) or after the ending time when the project will be finished and sold.
The endless projects partnership: After ending the construction period and when the project is ready to start the exploitation period, the Pazireh certificates will be transformed into the shares of the corporation.
The flow chart shows how depositing on finitude or ending projects can be settled.

### Description of FIG. 3

### The Logical Relation Among PLS Entities

### Assembly Method of FIG. 3:

### Part 1 Part 2

### Operations of the Entrepreneur

The entrepreneur of project goes to the PLS branch and offers her project.
The branch informs the entrepreneur about the conditions and regulations of getting financed through the secondary market information portal by Participation/Subscription Certificates. The accounting desk in the PLS branch receives funds related to the evaluation of proposals based on preliminary plans (according to the approved instructions) from entrepreneur about the proposed project, including feasibility reports, registration documents, work permits and other relevant information required to profile of project.
Profile of entrepreneur with her proposed plans and other relevant information will be filed and a copy is submitted to entrepreneur evaluation unit.
The entrepreneur evaluation unit evaluates entrepreneur records (if any) and based on pre-determined guidelines, on capability and technical capacity of entrepreneur to handle the project. Evaluation unit evaluates the project based on the relevant guidelines, such as list price of management and planning organization, the software records and other items. If positive evaluation is assessed for project plan, the type and amount of guarantees, share of investment are given to the entrepreneur. Fees related to the evaluation of projects are to be paid by the entrepreneur.
The desk of accountant/auditor evaluates the hypothecs proposed by entrepreneur. The cash down payment brought by the entrepreneur is received by the cashier. Information about the hypothecs and guarantees are registered in accountant/auditor desk according to the instructions. A code is delivered for the entrepreneur and he will be recognized by this code.
The contractor desk establishes a contract according to type of participation and receives other required documents to complete the file. A copy of contract is for the entrepreneur and another is kept in her file. All the information of the contract is saved in entrepreneur file with her code.
After contract establishment resources will be given to entrepreneur according to schedule of the contract. Copy of records will be transferred to the Trustee assigned by bank.
All documents according to the instructions including; budgeting, time schedule, resources required and allocation of resources, quality and performance control, reporting and completing of project must be provided to the Trustee. All documents and notes of costs must be supplied to Trustee for auditing process.
The reports of performance of entrepreneur should be supplied on schedule to auditing/accounting department. Any eventual stop must be processed by Trustee and be approved by concerned unit.
At the end of the project according to instructions and formulas the profit/loss of the project and shares of investors will be calculated by auditing/accounting department and transferred to their accounts. If stops or delays occurred according to report of Trustee the penalty will be calculated and charged. Force major stops will be evaluated according to related instructions.
If the entrepreneur has objection to reports of Trustee, arbitration will be formed according to the instructions.

### The Operations of Depositors

The depositor goes to information portal of the secondary market of Participate/Subscription certificates through internet or a PLS broker/branch, consults advisors and get informed of present projects/products and the regulation and resignation. Then choose of the following options:
1—Banking service/product: Participation in profit and loss of specific project
2—Banking service/product: Participation in profit and loss of a package of several projects
3—Banking service/product: Participation in profit and loss of Branch
After selection of the product, forms are to be filled and temporary document is recorded in computer database, the depositor goes to the cashier desk to receive the payment and finalize the registration. A new code is delivered for client according to the product.
All records of the depositor are saved on database with her identity and account information.
Then depositor goes to contract desk to establish contract. ID code and access information to internet secondary market is provided to depositor. A copy is saved in depositor records with contract number. Automatically a receipt is delivered according to type of the product after the signature of the contract.
At end of Participation period (for both: single products and specific package of projects) the accounting/auditing desk proceeds to calculation of profit/loss share of depositor. The formulas are available automatically in computer software. The profit is transferred automatically to the depositor account after bank commission deduction.

### DESCRIPTION

### This Figure is a Detailed Expansion of FIG. 3. See the Description of FIG. 3.

This figure shows how the parts 1 to 9 of FIG. 5 may be assembled to create FIG. 5. Assembly method of FIG. 5:

1: The PLS banking is introduced as a complete riskless-oriented banking system with newly defined financial innovations/instruments of Mosharakah (participation) and Pazireh (subscripted) Certificates. This banking system not only stabilizes the financial institution/bank, borrower/entrepreneurs by keeping them from bankruptcy during crisis periods or volatile market conditions, but also makes the bank as an international institution which performs similar jobs as stock exchange markets for transactions of PLS products certificates through a secondary certificate market on internet. Depositors will also earn more stabilized benefits.

2: Two new financial innovations/instruments of Mosharakah (participation) and Pazireh (subscripted) Certificates are introduced for the first time that will be used instead of deposits and can be sold and bought on interne, banks, and other financial institutions as well.

3: A mechanism of internet-based sale and buy of Mosharakah and Pazireh Certificates is introduced.

4: In the PLS banking system of claim 1, new organization for bank/financial institution is defined with a Trustee (Amin) unit to supervise and control the good governance of entrepreneur (borrower) performance.

5: The PLS banking system of claim 1, wherein period of crisis, the entrepreneurs of investment projects are more protected from bankruptcy; consulting, contractors and constructors agents are not subject to serious financial defeats with PLS banking.

6: The PLS banking system of claim 1, wherein as the rate of benefit of depositors is dependent to real rate of return of the economy, depositors' benefit will get more stability through PLS banking.

7: The PLS banking system of claim 1, wherein as long as the PLS bank works as a financial intermediary and not as conventional banks and receives wages from depositors for supplying capital management services to depositors, will not meet bankruptcy in crises, economic volatilities, market fluctuations and bad economic conditions.

8: In the PLS banking system of claim 2, Pazireh Certificate is designed for endless projects that at the end of construction period and at the beginning of exploitation period, the Pazireh holders will become the shareholders of constructed project and the accounts of depositors, entrepreneur and banks are cleared.

9: In the PLS banking system of claim 2, Mosharakah Certificate is designed for finitude projects that at the end of construction period the constructed project is sold and by paying each party, the accounts of depositors, entrepreneur and banks are cleared.

10: The PLS banking system of claim 3, wherein financial innovations of Mosharakah and Pazireh Certificates make the bank/financial institution as an international portal performing similar jobs to a stock exchange market for transaction of PLS products certificates and can easily allocate and reroute resources to investments from anywhere in the world with simple interne connection.

11: In the PLS banking system of claim 3, new accounting framework is introduced with free interest rate calculation and based on duration time and money amount of participation.
